(19) United States
(12) Patent Application Publication
(10) Pub. No.: US 2024/0117669 A1
(43) Pub. Date: Apr. 11, 2024

(54) SPACER WITH DESICCANT WITHIN A TUBE-SHAPED CAVITY

(71) Applicant: PDS IG Holding LLC, Prairie Du Sac, WI (US)

(72) Inventors: Eric B. Rapp, Avoca, WI (US); David Rapp, Eden Prairie, MN (US)

(21) Appl. No.: 18/114,042

(22) Filed: Feb. 24, 2023

Related U.S. Application Data
(60) Provisional application No. 63/313,586, filed on Feb. 24, 2022.

(51) Int. Cl. E06B 3/663

(52) U.S. Cl. CPC E06B 3/66361; E06B 3/66328; E06B 2003/66395

(57) ABSTRACT

Various embodiments provide a window assembly comprising an insulated glazing unit and a frame. The frame can extend around the perimeter of the insulated glazing unit. The insulated glazing unit can include a first sheet of glass, a second sheet of glass, and a space frame disposed between the two sheets of glass. Various spacer designs are provided herein.

This application claims the benefit of U.S. Provisional Application No. 63/313,586, filed Feb. 24, 2022, the contents of which is herein incorporated by reference in its entirety.

### FIELD

Embodiments herein relate to spacers for insulated glazing unit.

### BRIEF DESCRIPTION OF THE FIGURES

Aspects may be more completely understood in connection with the following figures (FIGS.), in which:

FIG. 1 is a perspective view of an insulated glazing unit in accordance with various embodiments herein.

FIG. 2 is a cross-sectional view of an insulated glazing unit in accordance with various embodiments herein.

FIG. 3 is a perspective view of a spacer in accordance with various embodiments herein.

FIG. 4 is an end view of the spacer shown in FIG. 3 in accordance with various embodiments herein.

FIG. 5 is a side view of the spacer shown in FIG. 3 in accordance with various embodiments herein.

FIG. 6 is a perspective view of a spacer in accordance with various embodiments herein.

FIG. 7 is an end view of the spacer shown in FIG. 6 in accordance with various embodiments herein.

FIG. 8 is a perspective view of a spacer in accordance with various embodiments herein.

FIG. 9 is an end view of the spacer shown in FIG. 8 in accordance with various embodiments herein.

FIG. 10 is a perspective view of a spacer in accordance with various embodiments herein.

FIG. 11 is an end view of the spacer shown in FIG. 10 in accordance with various embodiments herein.

FIG. 12 is a perspective view of a spacer in accordance with various embodiments herein.

FIG. 13 is an end view of the spacer shown in FIG. 12 in accordance with various embodiments herein.

FIG. 14 is an end view of a spacer in accordance with various embodiments herein.

While embodiments are susceptible to various modifications and alternative forms, specifics thereof have been shown by way of example and drawings, and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

A window can generally include an insulated glazing unit with a frame surrounding the perimeter of the insulated glazing unit. The insulated glazing unit can include a spacer and two or more panes of glass.

Various embodiments of spacers are disclosed herein. A spacer can be positioned between two panes of glass. The spacer can be adhered to both of the panes of glass to define the insulated glazing unit (hereinafter “IGU”). Prior to assembly of the IGU, a spacer can be formed into a spacer frame that can generally have a similar shape as the perimeter of the panes of glass. The spacer can be inset from the perimeter of the panes of glass. The thickness of the spacer can define the size of the gap between the two panes of glass. The two panes of glass and the spacer can define an interpane space. The interpane space can be filled with a gas, such as argon or krypton. Providing a gas filled interpane space can increase the insulative properties of the IGU.

In some embodiments, the spacer can carry a desiccant or filler material. The filler material can absorb moisture that is within the interpane space. Without the absorption of the moisture within the interpane space, condensation can occur resulting in a foggy appearance and decreased visibility through the IGU.

Various spacers described herein can provide economical and structural advantages.

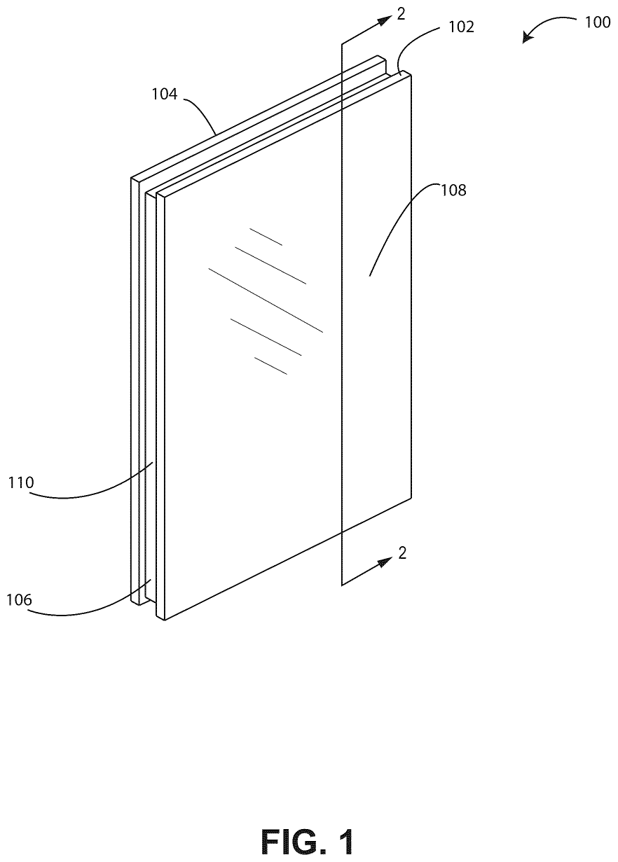

Referring now to FIG. 1, a perspective view of an IGU 100 is shown in accordance with various embodiments herein. The IGU 100 can include a first planar substrate or first pane of glass 102 and a second planar substrate or second pane of glass 104. A spacer 106 can be disposed between the two panes of glass 102, 104. The two panes of glass 102, 104 and the spacer 106 can define an interpane space 108.

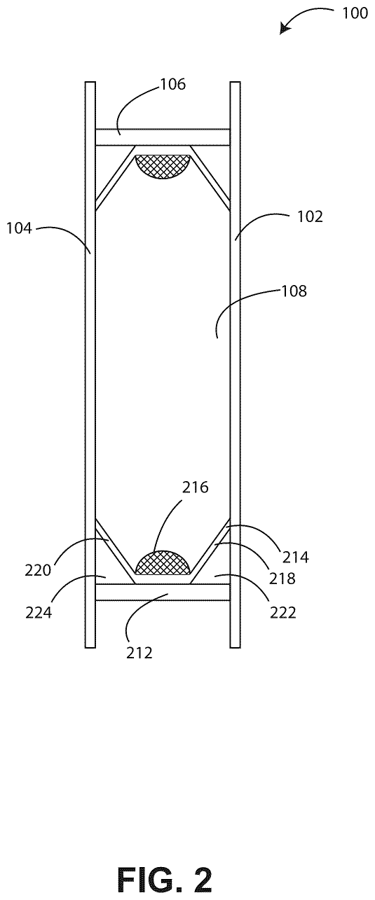

In various embodiments, spacer material can be in the form of a continuous strip. The spacer material can be formed into a spacer frame 110. The spacer frame 110 can be adhered to the panes of glass 102, 104. The panes of glass 102, 104 can be disposed on opposite sides of the spacer frame 110, such that the spacer frame 110 is disposed between the panes of glass 102, 104. While not entirely shown in FIG. 1, the spacer frame 110 of FIG. 1 is generally rectangular. The spacer frame 110 can have a similar shape as the perimeter of the panes of glass 102, 104. In some embodiments, the spacer frame 110 will be slightly smaller than the perimeter of the panes of glass 102, 104, such that the spacer frame 110 can be inset from the edge or perimeter of the panes of glass 102, 104 as shown in FIGS. 1 and 2.

Referring now to FIG. 2, a cross-sectional view of the IGU 100 taken along line 2-2 in FIG. 1 is shown in accordance with various embodiments herein. FIG. 2 shows the interpane space 108 defined by the inner surfaces of the panes of glass 102, 104 and the spacer 106.

The spacer 106 can include a base element 212 and a body element 214. In some embodiments, the body element 214 can carry a desiccant 216. The desiccant can be disposed on the body element 214. The body element 214 can define a volume, such that it projects in at least three dimensions. In contrast, in some embodiments, the base element 212 can be a generally planar or flat substrate, which the body element 214 can mount on or coupled to. The body element 214 can be adhered to the base element 212, such as with an adhesive or a mechanical connection.

In some embodiments, the body element 214 can include a first extension or leg 218 and a second extension or leg 220. The extensions or legs 218, 220 can project outwards or away from the base element 212 in a non-perpendicular and non-parallel manner. The extensions or legs 218, 220 can define an exterior angle of between 0° and 90° with the base element 212 and an interior angle of at least 90° and not more than 180°.

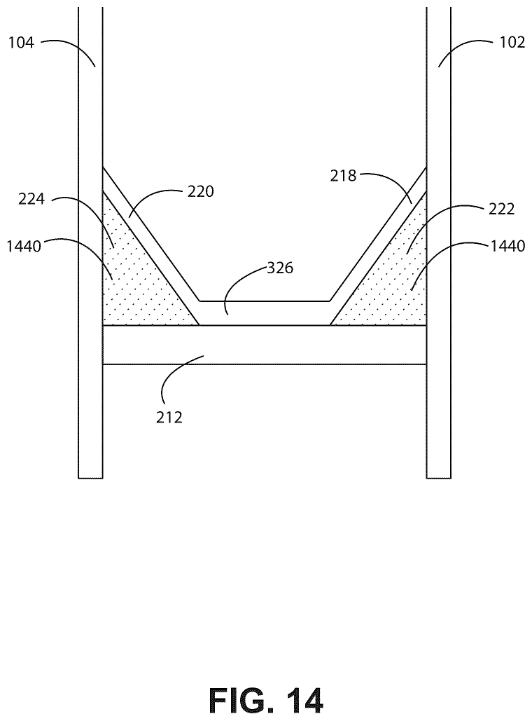

In various embodiments, the area 222 enclosed by the first leg 218, the first pane of glass 102 and the base element 212 can be filled with an adhesive, such as to attach or secure the spacer 106 to the first pane of glass 102. Similarly, the area 224 enclosed by the second leg 220, the second pane of glass 104 and the base element 212 can also be filled with an adhesive, such as shown in FIG. 14.

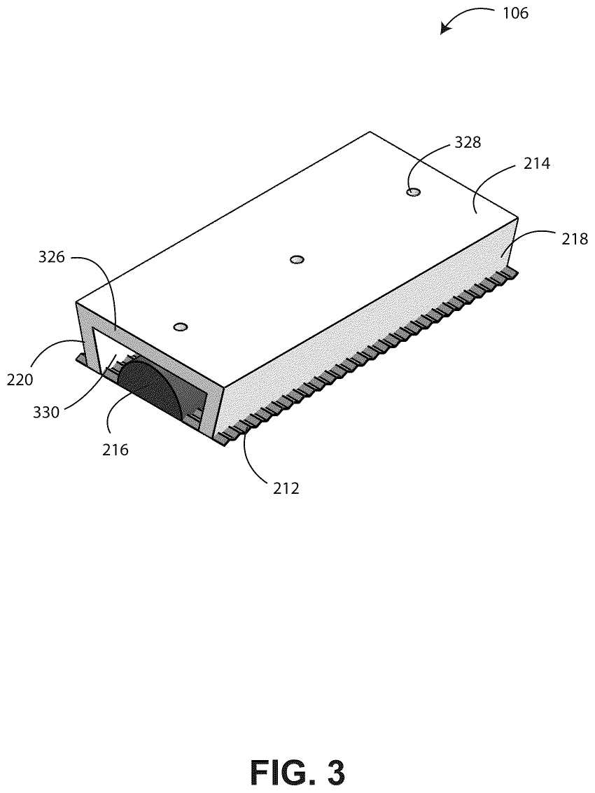

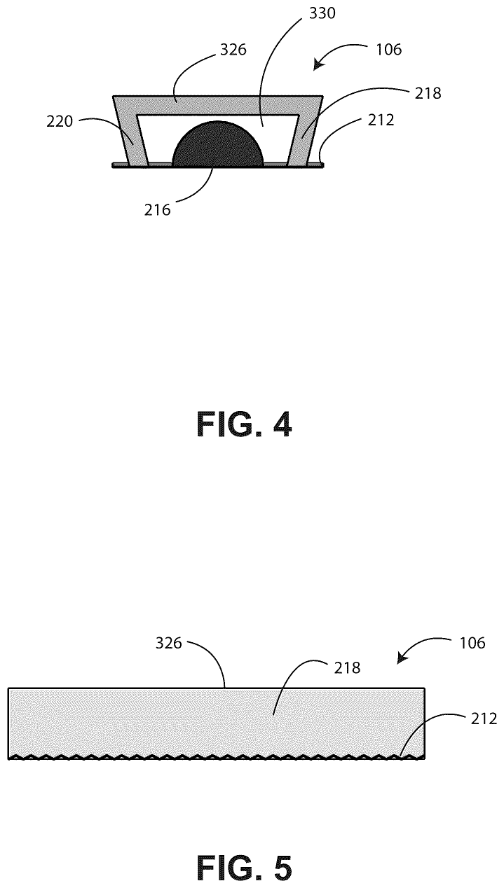

FIGS. 3-5 show various views of a spacer 106. FIG. 3 shows a perspective view of the spacer 106 in accordance with various embodiments herein. FIG. 4 shows an end view of the spacer 106 and FIG. 5 shows a side view of the spacer 106.

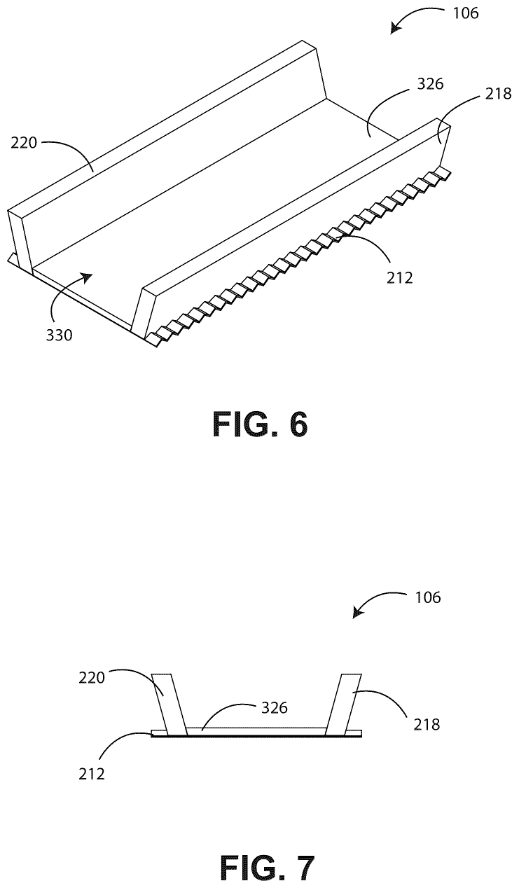

In some embodiments, the body element 214 can include a connecting portion 326 extending between the first leg 218 and the second leg 220. In some embodiments, the connecting portion 326 can be integrally formed or monolithic with the first leg 218 and the second leg 220. In some embodiments, the connecting portion 326 can be separated or located away from the base element 212, such as shown in FIGS. 3-4. In other embodiments, the connecting portion 326 can be adjacent to or disposed on the base element 212, such as shown in FIGS. 6-7.

In various embodiments, the connecting portion 326 can define one or more breather hole 328. The breather holes 328 can allow gases to pass between the inner spacer volume 330 and the interpane space 108. In some embodiments, the desiccant 216 can be disposed within the inner spacer volume 330. The breather holes 328 allow the desiccant 216 to remove moisture from the air that would otherwise be trapped within the interpane space 108. In some embodiments, such as shown in FIGS. 3-4, the connecting portion can be spaced away from the base element 212, such that the inner spacer volume 330 in enclosed by the first leg 218, the second leg 220, the connecting portion 326, and the base element 212, with the exception of breather holes 328 and the ends of the spacer 106. In other embodiments, the inner space volume 330 can be at least partially open or only enclosed on three sides, such as shown in FIGS. 6-11.

As shown in FIGS. 3 and 4, the body element 214 and the base element 212 can define an inner spacer volume 330. In various embodiments, the inner spacer volume 330 can be at least partially occupied by a desiccant 216. In some embodiments, the desiccant 216 can be disposed on the base element 212 and at least partially enclosed by the body element 214, such as shown in FIGS. 3 and 4.

FIG. 5 shows a side view of a portion of a spacer 106. The spacer 106 can extend longitudinally, such that it has a length greater than its width and/or height. In various embodiments, the body element 214 and the base element 212 can be adhered together in a sealed manner or an airtight manner, such that under normal operating conditions air cannot pass between the connection of the body element 214 and the base element 212. In some embodiments, an adhesive can be applied to adhere the body element 214 with the base element 212, such as shown in FIG. 14.

FIG. 6 shows a perspective view of a spacer 106 in accordance with various embodiments herein. FIG. 7 shows an end view of the spacer shown in FIG. 6.

In some embodiments, the connecting portion 326 can be generally parallel with the base element 212. In some embodiments, the connecting portion 326 can be disposed against the base element 212, such as shown in FIGS. 6-7. The first leg 218 and the second leg 220 can extend from the connecting portion 326 and away from the base element 212.

In various embodiments, the body element 214 can define the inner spacer volume 330. The inner spacer volume 330 can be open or unenclosed, such as shown in FIGS. 6-7. A desiccant 216 can be disposed on the connecting portion 326 and thereby be exposed to the interpane space 108 for the removal of moisture.

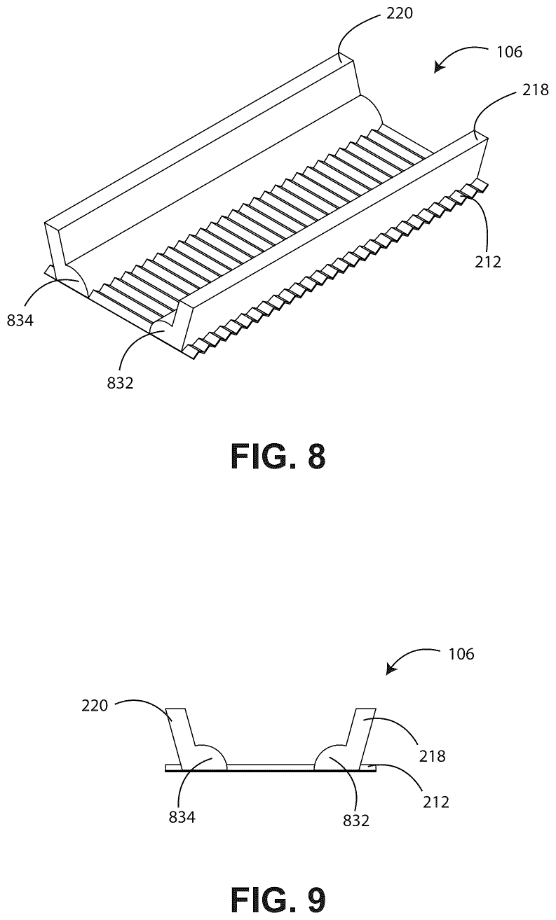

In some embodiments, the body element 214 can include a first leg 218 and a second leg 220 that are not connected with each other, such as shown in FIGS. 8-11. FIG. 8 shows a perspective view of a spacer in accordance with various embodiments herein. FIG. 9 shows an end view of the spacer shown in FIG. 8.

The first leg 218 and the second leg 220 can each be individually or separately disposed on the base element 212. In various embodiments, the first leg 218 can have a first support portion 832 and the second leg 220 can have a second support portion 834. In some embodiments, the support portions 832, 834 can be integrally formed with their respective legs 218, 220. The support portions 832, 834 can be disposed inwards or towards the center of the base element 212 relative to the legs 218, 220. The support portions 832, 834 can support the legs 218, 220 such that the legs 218, 220 can maintain their upright angled positions. The support portions 832, 834 can be bump out portions or extended portions of the legs 218, 220 such that the legs 218, 220 can have a larger base or bottom portion to better withstand forces that could otherwise result in the legs 218, 220 falling, failing or losing their desired positions.

As shown in FIG. 9, the support portions 832, 834 can be formed, molded, or extruded with the legs 218, 220. The support portions 832, 834 can be disposed on the base element 212. The support portions 832, 834 can be adhered to the base element 212.

In various embodiments, the support portions 832, 834 can have a rounded outer surface. In some embodiments, the support portions 832, 834 have a cross-sectional shape that is a portion of a circle, such as greater than 90° of a circle as the leg extends away from being perpendicular with the base element 212.

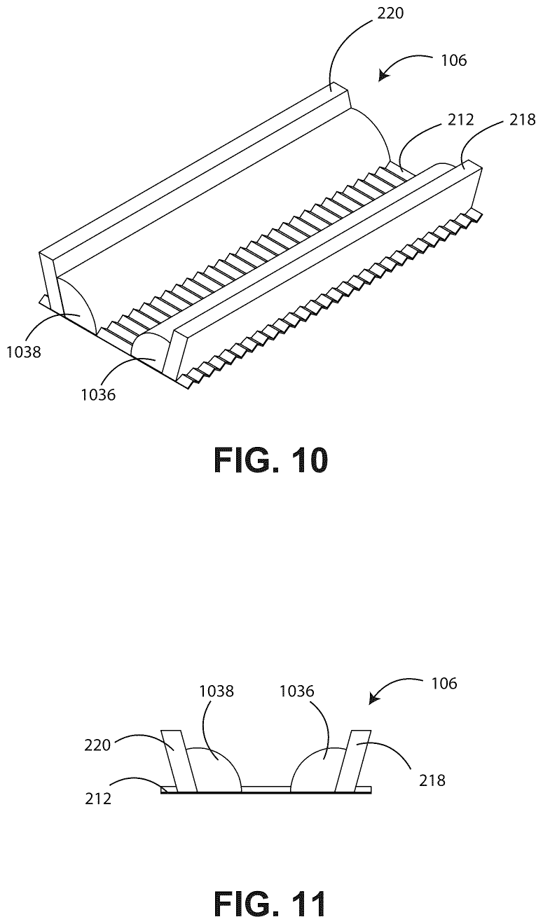

FIGS. 10-11 show a similar example of the spacer 106 as shown in FIGS. 8-9. FIG. 10 shows a perspective view of a spacer 106 in accordance with various embodiments herein. FIG. 11 shows an end view of the spacer 106 shown in FIG. 10.

In some embodiments, the first leg 218 and the second leg can each be individually or separately disposed on the base element 212. The first leg 218 can have a first support portion 1036 and the second leg 220 can have a second support portion 1038. In some embodiments, the legs 218, 220 can be separate elements from the support portions 1036, 1038, such as shown in FIGS. 10-11. The support portions 1036, 1038 can be coupled or adhered to the respective legs 218, 220.

In some embodiments, the legs 218, 220 can be coupled or adhered to the support portions 1036, 1038. After the legs 218, 220 are coupled or adhered to the support portions 1036, 1038, the legs 218, 220 and the support portions 1036, 1038 can be coupled or adhered to the base element 212.

In other embodiments, the legs 218, 220 can be coupled or adhered to the base element 212. After the legs 218, 220 are coupled or adhered to the base element 212, the support portions 1036, 1038 can be added. The support portions 1036, 1038 can be coupled or adhered to the respective legs 218, 220, the base element 212, or both.

In various embodiments, the support portions 1036, 1038 can have a rounded outer surface. In some embodiments, the support portions 1036, 1038 have a cross-sectional shape that is a portion of a circle, such as greater than 90° of a circle as the leg extends away from being perpendicular with the base element 212.

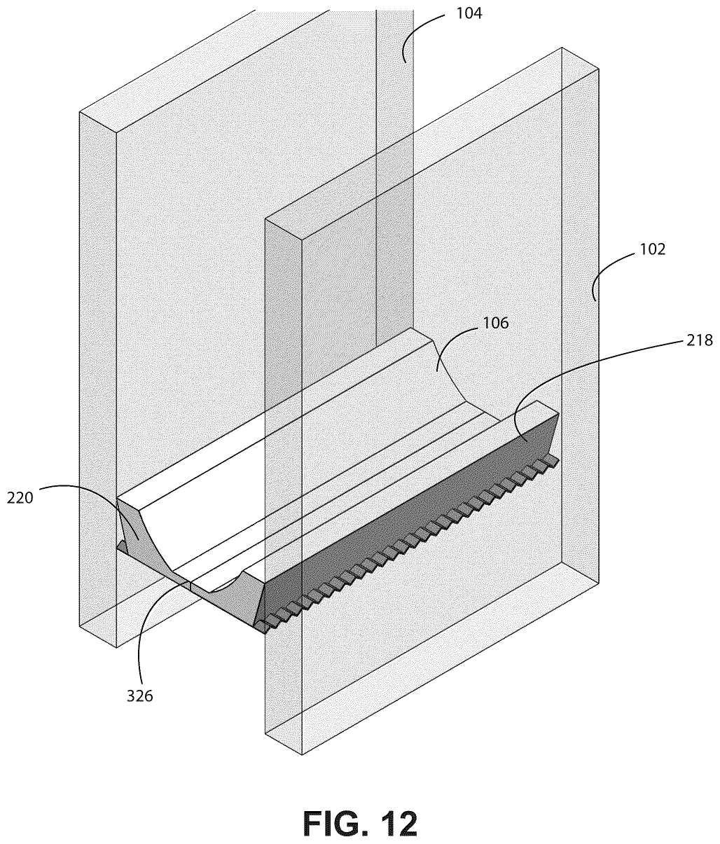

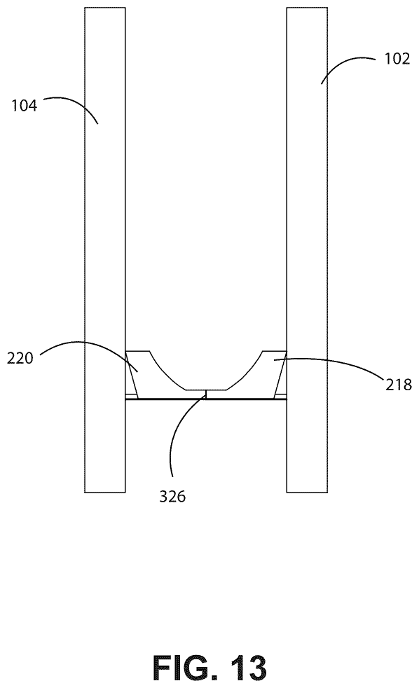

FIG. 12 shows a perspective view of a spacer 106 between two panes of glass 102, 104 in accordance with various embodiments herein. FIG. 13 shows an end view of the spacer 106 and glass 102, 104 shown in FIG. 12.

In some embodiments, the legs 218, 220 can be integral with each other and with a connecting portion 326. In some embodiments, each leg 218, 220 can be integral with a portion of the connecting portion 326, such that the body element 214 includes two separate sections. The first section can include the first leg 218 and a portion of the connecting portion 326, and the second section can include the second leg 220 and the remaining portion of the connecting portion 326.

In some embodiments, the legs 218, 220 can include a planar or straight portion, such as the portion defining a segment of the areas 222, 224, and a curved or non-planar portion, such as the portion defining the inner spacer volume 330 as shown in FIG. 13.

FIG. 14 shows an end view of a spacer in accordance with various embodiments herein. In various embodiments, the seal between the base element 212 and the panes of glass 102, 104 provides the airtight seal such that air cannot escape or enter the interpane space. As such, there can be a larger amount of adhesive 1440 disposed closer to the intersection of the base element 212 and the panes of glass 102, 104 than there is at the intersection of the legs 218, 220 and the panes of glass 102, 104.

### Desiccant

In various embodiments, the spacer can include a desiccant or matrix with a desiccant to remove moisture from the interpane space. The desiccant can be configured to absorb moisture in the surrounding air that the desiccant is exposed to. Removing the moisture from the interpane space can result in increased visibility through the IGU and increased efficiencies of the IGU.

### Base Element

In various embodiments, the base element can be a generally planar substrate. In some embodiments, the base element can include a corrugated substrate, which can be generally planar. In some embodiments, the base element can be a rectangular prism. In some embodiments, the base element can include or be formed from a metal, such as aluminum, steel or stainless steel.

Various components can be coupled to or disposed on the base element, such as the body element or the desiccant.

### Body Element

In various embodiments, the body element can include a polymer, such as nylon. In various embodiments, the body element can be an extruded polymer. In some embodiments, the body element can be monolithic or integrally formed such that the body element is a single continuous component. In other embodiments, the body element can include separate extruded portions. The separate extruded portions can be joined together or remain separated.

In various embodiments, the body element can have a substantially uniform thickness, such that the polymer can dry, settle, or cure at a common rate throughout the body element.

In some embodiments, such as shown in FIGS. 3-4 and 6-7, the legs can be planar or generally straight. In some embodiments, such as shown in FIGS. 12-13, the legs can be at least partially curved.

In some embodiments, such as shown in FIGS. 3-4, the legs can have a uniform thickness. In some embodiments, such as shown in FIGS. 12-13, the legs can have a varying thickness.

In various embodiments, the body element can be extruded onto the base element after the desiccant is positioned on the base element. In other embodiments, the body element can be extrude onto the base element and then the desiccant can be positioned on the body element.

### Dimensions

In various embodiments, the width of the spacer can define the size of the gap between the two panes of glass. In some embodiments, the width of the spacer can be about 0.5 inches. In some embodiments, the width of the spacer can be at least 0.25 inches and not more than 1 inch. The body element and the base element can have similar widths as the spacer.

In various embodiments, the height of the spacer can be about 0.17 inches. In some embodiments, the height of the spacer can be at least 0.1 inches and not more than 0.25 inches.

In various embodiments, the height of the base element can be about 0.011 inches or about 0.017 inches. In some embodiments, the height of the base element can be at least 0.005 inches and not more than 0.5 inches.

In various embodiments, the thickness of a leg can be about 0.045 inches. In some embodiments, the thickness of a leg can be at least 0.02 inches and not more than 0.1 inches.

### Spacer Frame Geometries

As mentioned above, the spacer can be formed into a spacer frame. In various embodiments, the spacer frame is an enclosed loop, such that the two ends of a length of spacer contact each other to form a continuous spacer frame. In many embodiments, the spacer frame can be in the shape of a rectangle with four sides, such as when the spacer frame is being adhered to rectangular panes of glass. The spacer frame can be other shapes as well. In various embodiments, the spacer frame can be formed to have a similar shape as the panes of glass that it will be adhered to. As an example, the spacer frame can be formed into a rectangle, a square, a trapezoid, a triangle, a pentagon, a hexagon, a heptagon, an octagon, or other regular or irregular shapes.

In various embodiments, the spacer can be cut to define the corners of a spacer frame. The cut portions of the spacer can aid in bending the spacer into the desired spacer frame shape. Cutting the spacer can include removing a portion of the spacer to facilitate the spacer bending at the desired location into the desired angle. As an example, in some embodiments, a triangle can be cut and removed from an inner portion (inner of the spacer frame) of the spacer to facilitate the bending of the spacer into a spacer frame with a corner of the spacer frame located where the triangle portion was removed from the spacer.

It should be noted that, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

As used herein, the recitation of numerical ranges by endpoints shall include all numbers subsumed within that range (e.g., 2 to 8 includes 2.1, 2.8, 5.3, 7, etc.).

The headings used herein are provided for consistency with suggestions under 37 CFR 1.77 or otherwise to provide organizational cues. These headings shall not be viewed to limit or characterize the invention(s) set out in any claims that may issue from this disclosure. As an example, although the headings refer to a “Field,” such claims should not be limited by the language chosen under this heading to describe the so-called technical field. Further, a description of a technology in the “Background” is not an admission that technology is prior art to any invention(s) in this disclosure. Neither is the “Summary” to be considered as a characterization of the invention(s) set forth in issued claims.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

What is claimed is:

1. A window assembly, comprising:
an insulated glazing unit, the insulated glazing unit comprising:
a first pane of glass;
a second pane of glass; and
a spacer frame disposed between the first pane of glass and a second pane of glass, wherein the spacer frame, the first pane of glass, and the second pane of glass define an interpane space;
a frame surrounding the insulated glazing unit.

2. The window assembly of claim 1, wherein the spacer frame comprises a spacer.

3. The window assembly of claim 2, wherein the spacer comprises:
a base element;
a first extension coupled to the base and extending away from the base element; and
a second extension coupled to the base and extending away from the base element.

4. The window assembly of claim 3, wherein the first extension and the second extension are made of a polymer.

5. The window assembly of claim 4, wherein each the first extension and the second extension extend away from the base at a non 90 degree angle.

6. The window assembly of claim 5, wherein the first extension and the second extension are not parallel with each other.

7. The window assembly of claim 6, wherein the first extension and the second extension are connected across the base element.

8. The window assembly of claim 7, wherein the base element is corrugated metal.
